(19) United States
(12) Patent Application Publication
(10) Pub. No.: US 2014/0139283 A1
(43) Pub. Date: May 22, 2014

(54) EXTREME ENVIRONMENT COMPENSATION CONTROLLER FOR INTEGRATED CIRCUITS

(71) Applicants: Todd S. Grimes, Lebanon, OH (US); David S. Van Sickle, Centerville, OH (US)

(72) Inventors: Todd S. Grimes, Lebanon, OH (US); David S. Van Sickle, Centerville, OH (US)

(73) Assignee: RNET TECHNOLOGIES, INC., Dayton, OH (US)

(21) Appl. No.: 13/552,767

(22) Filed: Jul. 19, 2012

(51) Int. Cl. H02M 3/156

(52) U.S. Cl. CPC H02M 3/156
USPC 327/513; 327/509

(57) ABSTRACT

A circuit monitors an electronic circuit for the effects of extreme temperatures, high Total Ionizing Dose (TID), very low (down to sub-threshold) supply voltages, process variations, and other performance altering phenomena. The circuit then generates signals that are applied to the electronic circuit to compensate for these effects. The design generates voltages that are applied to either body terminals of semiconductor technologies (e.g. MOSFET, CMOS, SOI, and others) or bottom gates of independently double gated technologies to provide compensation. The design includes a reference circuit that is adjusted until its performance is restored. The signals found that compensate the reference circuit are applied throughout the IC.

### STATEMENT REGARDING FEDERALLY SPONSORED RESEARCH OR DEVELOPMENT

This invention was made in part with Government support under Contract Numbers NNX09CF29P, NNX10CB47C, NNX11CF74P, and NNX12CA84C, FA9453-10-M-0152, and W31P4Q-09-C-0393 awarded by NASA, Air Force, and DARPA. The Government has certain rights in this invention.

### FIELD OF THE INVENTION

The invention of the present application relates in general to electronic integrated circuits and, more particularly, to compensating for negative effects of extreme environments on the operation of the circuit.

### BACKGROUND OF THE INVENTION

Integrated circuits do not always perform optimally or even correctly in non-ideal operating environments and conditions. A circuit is designed to perform best under specific conditions. Deviations from the ideal condition alter the properties of the circuit elements and change the operation of the circuits themselves. A brief description of such conditions follows.

Radiation effects on MOSFET circuits are typically categorized as single event effects (SEE) or total ionizing dose (TID). This technique specifically addresses TID effects in which an absorbed dose of electrons and/or protons due to an irradiated environment cause device threshold shifts and other problems. Excessive charges can build up in a MOSFET transistor, eventually causing leakage currents to form between the drain and source. An affected transistor may turn on or off inadvertently due to a shift in threshold voltage, which could result in excessive current draw and possible failures. The ultimate consequence would be the permanent damage of the transistor and associated circuits.

An electronic circuit is generally designed to operate with a certain range of power supply voltage. Lowering the supply voltage is a simple way to dramatically lower power consumption. When supply voltages are lowered to an extreme, the circuit could be considered to be operating in Ultra-Low Power (ULP) mode. A supply voltage that is lower than the normal threshold voltage of transistors is referred to be operating in sub-threshold. The problem is that lowering the supply voltage alters the operating properties of the transistors, causing an imbalance in the current drive ratios between pull-up and pull-down networks. These are generally comprised of complementary P and N devices, but can be made of one type. This imbalance leads to poor performance or a loss of functionality.

Similar phenomenon occurs under other environmental extremes, such as temperature. Extreme high or low temperatures alter the behavior of transistors as well.

Fabrication process variations also lead to unpredictable pull-up/down drive ratios.

Multiple active circuit mitigation techniques have been developed for the above phenomena.

A Dynamic Threshold Voltage Control (DTVC) developed at RNET dynamically compensates for drifting threshold voltages in a electronic circuit by adjusting bias voltages at the body terminals of semiconductor technologies (e.g. MOSFET, CMOS, SOI, and others) or bottom gates of independently double gated technologies to provide compensation. This approach utilizes an active feedback mechanism to bring the electronic circuit back into tolerance. This method can provide active mitigation of effects from TID, temperature, and process variations.

RNET's “Current Drive & Monitor Compensation” (CDMC) is a technique that allows dynamic switching between normal operation and extreme ULP modes. CDMC allows optimal operation of a circuit at a wide range of supply voltages, (i.e. sub-threshold to super-threshold modes of operation). CDMC is partially based on a static body biasing technique called Adaptive Beta Ratio Modulation (ABRM) developed at Purdue University for ULP SRAM circuits.

Accordingly, there is a need for a more general approach that can actively compensate for the aforementioned environmental effects to ensure the operational integrity of the primary electronic circuit.

### SUMMARY OF THE INVENTION

The present invention satisfies this need by combining techniques that actively compensate for all of the above phenomena to actively and simultaneously correct for potential erroneous operation. The mechanism chosen to implement the compensation controls the bias voltage of body terminals of standard MOSFET technologies (e.g. CMOS, SOI) or the bottom gate of independent double gate process technologies.

It has been established that manipulating the body bias of CMOS or the bottom gate bias on independent double gate SOI technologies provides a mechanism for manipulating the threshold voltage of the transistors (see U.S. Pat. Nos. 6,853,470 and 6,232,794). This provides a method for compensation of the aforementioned non-ideal conditions. The innovation presented here is a specific compensation model using body/bottom gate biasing and an overall system to automate the application of said compensation model.

The DTVC model for TID and temperature effects involves tuning a reference circuit until its DC balance point is restored to a specified fraction of the supply voltage. “DC balance point” in this case is defined as the input voltage for which the DC output of a CMOS circuit is equal to its DC input. Simulations have established that this same condition can be used to restore circuit operation under extremely low supply voltage conditions and process variations.

A circuit has been designed to automatically generate the bottom gate/body bias necessary to restore the DC balance point of a reference circuit that is operating at the same conditions as the rest of the device. The same bias is used to compensate for all circuits of a specific class within a device.

The original circuit and technique were developed with and are very well suited for use with a specific process technology, an independent double-gate (IDG) Silicon-on-Insulator (SOI) CMOS. The IDG SOI bottom gate technology and additional radiation tolerance benefits of such are described in the referenced patents of Hackler et al.

The presented technique is not limited to a specific technology and will work with any CMOS technology, including other SOI technologies and conventional CMOS with body biasing or similar methods.

### BRIEF DESCRIPTION OF THE DRAWINGS

The following detailed description of the preferred embodiments of the present invention can be best understood when read in conjunction with the following drawings, where like structures are indicated with like reference numerals, and in which:

FIG. 1 is an illustration the general control design which uses a reference circuit and feedback loop to automate the compensation scheme described in this patent.

FIG. 2 illustrates a combined DTVC/ULP Controller Simulation Schematic, which comprises the Extreme Environment Compensation Controller. This is a specific high-level example description of the overall feedback mechanism used by the design.

FIG. 3 is a State Machine Diagram illustrating an example controller behavior that utilizes a particular binary search pattern, although other patterns may be utilized.

FIG. 4 is the output from the DTVC/ULP Controller.

FIG. 5 is a simulation output illustrating the automatic compensation of the DTVC/ULP for Various V_{VDD} (power supply voltage) with a specific Vt (threshold voltage) shift.

### DETAILED DESCRIPTION OF THE INVENTION

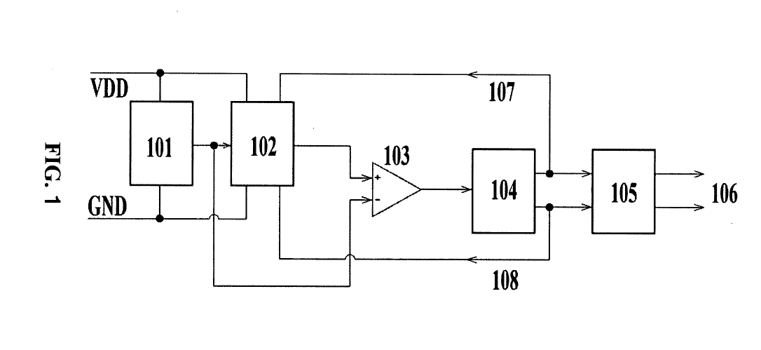

This simplified model of the technique being presented can be summarized as such: If a CMOS circuit's DC balance point is a specific fractional ratio of the supply voltage, the pull-up and pull-down networks are carrying a current related to the fractional ratio between logic states, and so are reasonably balanced. Also: the P and N body bias or bottom gate voltages that restore the DC balance point of a reference circuit should balance any CMOS circuits of a similar class throughout an IC or device that is subject to the same conditions as the reference circuit if applied to their P and N transistors respectively. This compensation mechanism can be automated with a control scheme that is described in FIG. 1.

The control scheme contains an independent reference network 101 that is less affected (ideally not affected at all) by the non-ideal conditions than the active circuitry of the CMOS device. Its output should be half of the supply voltage, but could be something else if a specific ratio between the pull-up and pull-down networks is desirable. This voltage is used as input to a reference circuit 102 that is under the same conditions as the CMOS device to be compensated. The outputs of both the independent reference network and the reference circuit are compared by analog comparison circuitry 103. The bias generation and control circuitry 104 monitors the output of the analog comparison circuitry and manipulates the body/bottom gate bias of the P and N devices, 107 and 108, of the reference circuit until such bias is determined that ensures that the outputs of the independent reference network and reference circuit are equal. Once this condition is achieved, bias latch and distribution circuitry 105 stores the bias voltages and they are distributed to all of the transistors 106 of the primary CMOS circuits under the same conditions and of the same class as the reference circuit. Because of slight variations in power supply voltages and other factors, hysteresis could be built into the design, such that the outputs from the voltage divider and reference circuit only need to be in a specific range from each other before a balanced circuit is indicated. This system can be replicated for as many reference circuit/circuit classes as necessary for an application. The control scheme utilized voltage signals throughout to determine whether or not a balance between the pull-up and pull-down networks exists and applies compensation appropriately. However, other electrical phenomena may be utilized in the control scheme, such as currents rather than voltages depending on the specific design of the controller.

What follows is a description of the development of a specific example/instance of the compensation scheme that was created and simulated to demonstrate the invention. It is a narrow and specific implementation of the general scheme and is not intended to limit the scope of the innovation, which is described in general above.

Development of the general compensation model started with simulations that were performed on some simple standard logic circuits to determine bottom gate bias voltages to restore the DC balance point in low V_{DD} operation. In the general case, the DC balance point is the condition in which the output of a complementary circuit matches its input. The goal for this example was to tune the circuit so that its DC balance point was exactly half of the supply voltage. This condition is considered an indication that the pull-up to pull-down drive current ratios of the complementary circuit is balanced. If there is any particular advantage to doing so, one could adjust the balance point to some other arbitrary voltage level.

The same voltages that restored the DC balance point in the simple reference circuits were tried in simulations of more complex circuits to determine their effectiveness in compensating for ULP conditions. It was shown that these conditions could restore or improve operation of more complex digital logic circuits operating in non-radiated ULP modes.

Simulations were repeated for a reference circuit (i.e. an inverter) to find its DC balance point under both low power supply and high TID conditions. High TID conditions were simulated by modifying the threshold voltage parameters within the transistor SPICE models. Specific bottom gate offsets to restore the DC balance point of the reference inverter under various TID and ULP conditions were used. It was found that a change in Vt requires a larger change in bias voltage than a change in the supply voltage. This means that compensating for ULP modes requires a much higher resolution (finer control) bias than compensating for TID.

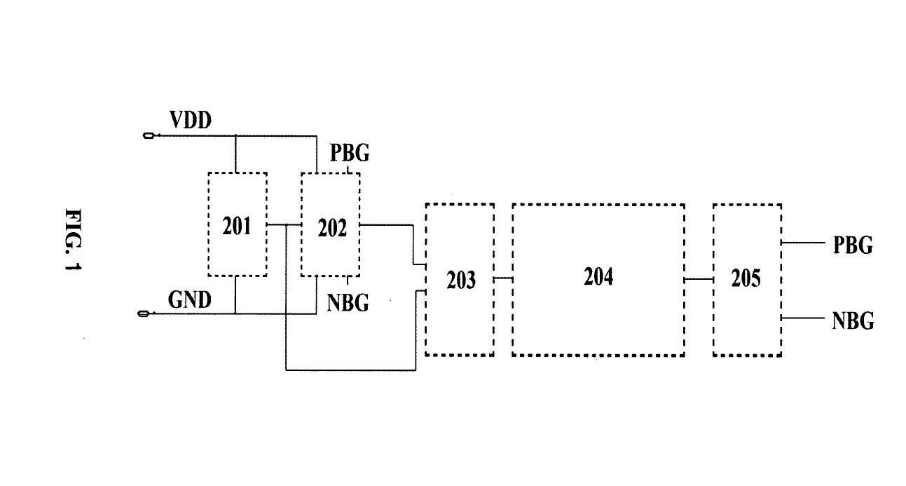

An improved DTVC/ULP control circuit (FIG. 2) that is capable of this resolution was developed. It uses a specific digital circuit and a DAC (digital-to-analog converter) to output a bias voltage with N bits of resolution. The design is scalable to any necessary precision. The initial design and all example simulations are based on an independent double gate process technology, but it can be applied to any CMOS based process. It should be noted that the intent is to illustrate the general design, not any specifications, which can vary by application. This specific preliminary design uses 12 bits for 4096 steps of precision, but the overall design is not limited to a specific resolution. It is intended that an appropriate resolution be chosen when tailoring the design to a specific application. Again, for this example only, this corresponds to a resolution of 0.44 mV over a 1.8V range (+/−0.9V).

The example design finds the bias voltage that restores a reference circuit's DC balance point to ½ V_{DD}, regardless of whether it is shifted due to a change in supply voltage, temperature, TID exposure, process variations, or any other physical mechanism that affects Vt. Transistors in the reference circuit are affected by all of these things, but the simple resistor-based voltage divider used in this example that provides the ½ V_{DD} for comparison lacks transistors, and will not be so affected by these conditions. The input of the reference circuit is the ½ V_{DD} signal. Its output is connected to a comparator circuit along with the with the ½ V_{DD} signal. The bias of the bottom N- and P-type gates, NBG and PBG, of the reference circuit are adjusted until the output of the reference voltage equals its input, or ½ V_{DD}.

The bias is generated by the output of the DAC controlled by a digital state machine, but designs may utilize a continuous analog feedback circuits. The state machine version monitors the output of the comparator, which indicates whether the bias must be increased or decreased. The state machine tries both extreme case outputs, than narrows its output one bit at a time until the output of the DAC biases the reference circuit as closely as possible to its DC balance point.

The reference circuit need not be an inverter. Bias voltages for the 1× inverter would make the best general purpose bias voltage for most CMOS circuits, since they are balanced using similar P/N width ratios. For some more complex circuits, like flip-flops, it may be beneficial to develop another reference circuit with a more suitable DC balance profile. There is no rule that a chip needs to have only one DTVC/ULP control circuit.

Once the bias is determined, it must be either sampled by a sample and hold circuit (SH) or the value of the DAC must be latched to a register with its own DAC so that the previous bias stays stable while a new bias is calculated. This running bias must be distributed through the device's circuitry using power efficient, high current, unity gain voltage amplifiers. Such a configuration also allows for significant power savings, since most of the circuit can be powered off most of the time. It only needs to be on when it is necessary to calculate new bias values. It is necessary to recalculate the compensation bias prior to any change in the supply voltage of the device circuitry, as well as when a significant amount of TID exposure has occurred. It is expected that Vt shifts due to TID gradually, and can be compensated for by running the bias calculation periodically, and does not need to run very often, except in very specific applications.

Radiation hardness of the DTVC/ULP controller itself will come from a combination of circuit simplification, other Radiation Hardened by Design (RHBD) techniques, and/or possibly its own, smaller, course grained DTVC circuit. That circuit does not need the high precision necessary to compensate ULP modes. It can be run at the most stable full-scale supply voltage every time it is used, since it is not run very often, and it will not be a very large power drain. Full voltage ranges will be available as they are required by analog components to test the full range of bottom gate bias. The simple DTVC only needs to ensure the controller's non-optimal, but correct functionality in high TID and other extreme conditions.

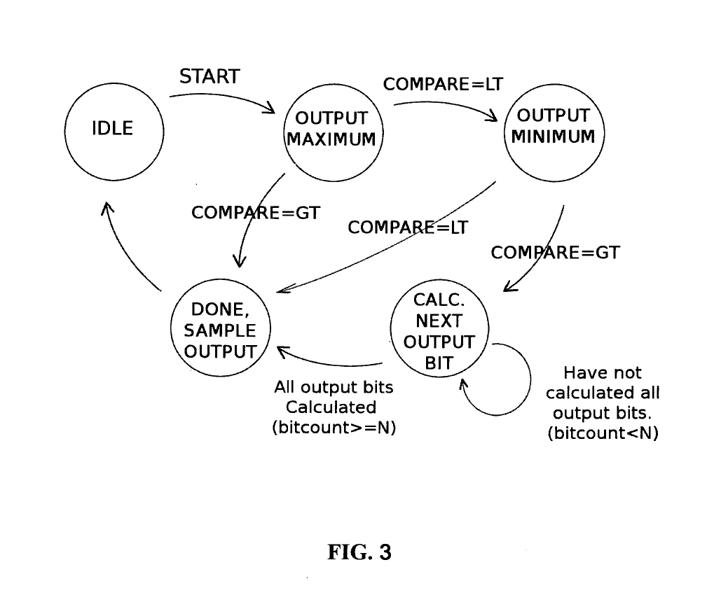

The new ULP/DTVC controller design has been simulated using spice models. FIG. 2 shows a schematic diagram of this instance of the circuit. In this version, the condition independent reference network is represented by a simple resistive voltage divider 201, working on the assumption that the passive devices are less susceptible to extreme conditions than the active devices. The reference inverter 202 is an extracted SPICE model of a 1× inverter standard logic cell used in a rad-hard FPGA design. Note that the design is not limited to the reference circuit used in this example. The analog comparison circuitry is represented by an ideal comparator 203, which is a voltage source that outputs logic “high” when the “A” input voltage is greater than its “B” input voltage, and outputs a “low” voltage otherwise. The bias generation and control circuitry is represented by the combination 204 of a digital state machine followed by a digital-to-analog converter, or DAC. FIG. 3 is a diagram describing one potential state machine functionality. The state machine is implemented using standard logic cells and flip flops that are radiation hardened. The state machine provides control of the circuit. The implementation of this functionality is not limited to a state machine followed by a DAC. It could be implemented in a number of ways, including all-analog circuitry that would provide more continuous compensation.

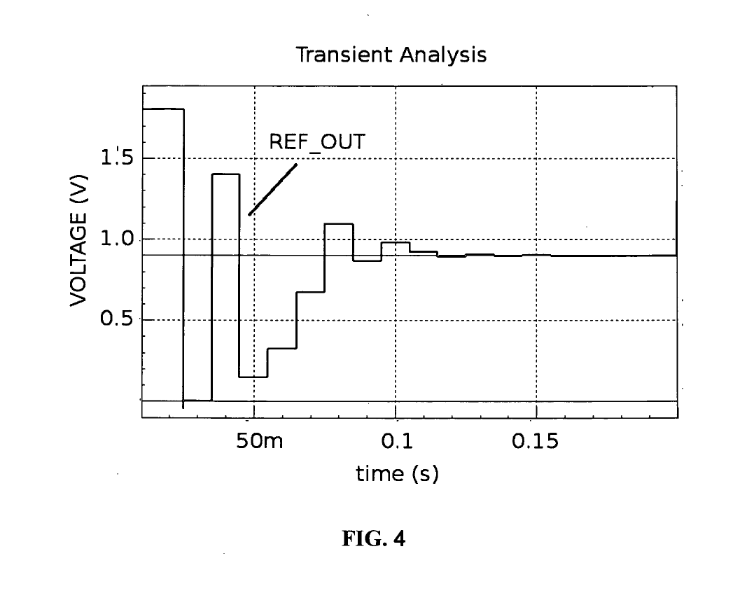

The state machine adjusts the bias voltages and performs a binary search pattern to narrow the output of the reference circuit to ½ V_{DD}. For each source the voltage, the “go” signal starts the state machine sequence and the clock is run until the stop signal goes high, indicating that the sequence is finished. At each rising edge of the clock during operation, if the reference output is too low, it will increase it, or vice versa. The process is illustrated in a simulation in FIG. 4. The design is not limited to a binary search. Other search patterns, as well as continuous analog feedback are also possible, which can further limit any delay of the circuit for a specific application.

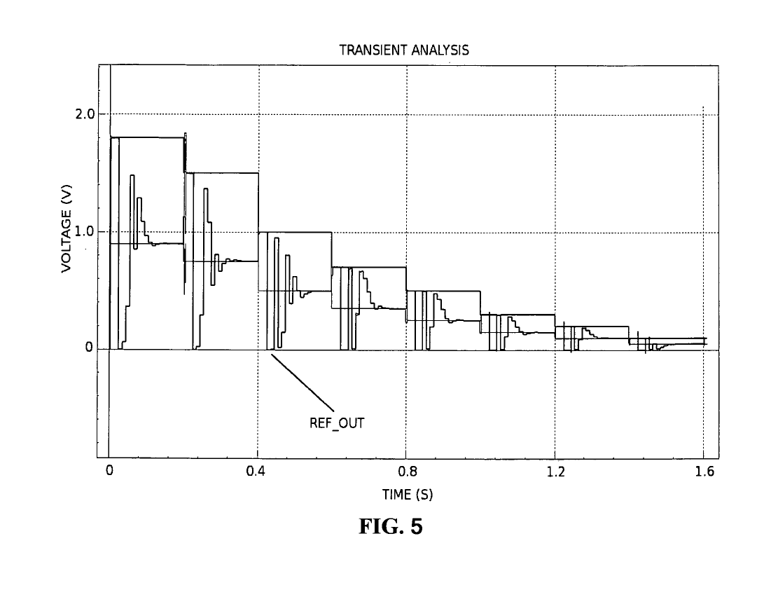

For a given level of Vt shift (simulated TID), the simulation was run several times, sweeping the source voltage, V_{DD}. The simulation in FIG. 5 shows bottom gate bias searches over a range of V_{DD} for a specific Vt shift. The bottom gate bias found by the ULP/DTVC circuit in all of these simulations are all within a very small margin of error from the values found in the manual SPICE simulations.

The invention has been described in association with a preferred embodiment, it should be understood that various modifications, additions and alterations may be made to the invention by one skilled in the art without departing from the spirit and scope of the invention as defined in the appended claims.

What is claimed is:

1. A novel mechanism to actively mitigate the effects of multiple environmental conditions on MOSFET, CMOS, and independent double gate circuits comprised of an independent reference network, dependent reference circuit, a comparison circuit, bias generation and control circuit, and bias latch and distribution network.

2. The mechanism claimed in claim 1 will compensate for the drifting threshold voltages caused by high total ionizing dose (TID) conditions.

3. The mechanism claimed in claim 1 will compensate for the effects of extreme high and/or low temperature conditions.

4. The mechanism claimed in claim 1 will compensate for the effects of altering the supply voltage for the purpose of low power, ultra-low power (ULP), sub-threshold operation, or any other reason.

5. The mechanism claimed in claim 1 will compensate for process variation effects.

6. The mechanism claimed in claim 1 will automatically compensate for any other phenomenon that shifts the threshold voltage of MOSFET, CMOS, and independent double gate circuits.

7. The mechanism claimed in claim 1 will compensate for the effects of any other phenomenon that alters the drive current ratio between the complementary P- and N-type devices in MOSFET, CMOS, and independent double gate circuits.

8. The compensations claimed in claims 2 through 7 can be handled automatically and dynamically if a specific implementation of the design is made to do so.

9. All of the aforementioned claims are subject to practical limitations. The method/design improves performance under these types of conditions, but there will always be a further extreme for which no amount of compensation will be of use.
